(19) United States
(12) Patent Application Publication
(10) Pub. No.: US 2008/0012627 A1
(43) Pub. Date: Jan. 17, 2008

(54) System and method for low voltage booster circuits

(76) Inventor: Yosuke Kato, Kanagawa (JP)

Correspondence Address: KLEIN, O'NEILL & SINGH, LLP, 43 CORPORATE PARK, SUITE 204, IRVINE, CA, 92606, US

(21) Appl. No.: 11/486,303

(22) Filed: Jul. 13, 2006

(51) Int. Cl. G05F 1/10

(52) U.S. Cl. 327/536

(57) ABSTRACT

A system and method of reducing current consumption in a low voltage booster circuit is provided. The method includes the steps of (a) enabling an input signal to activate plural out of phase clocks; and (b) disabling the input signal after a pre-determined time and after an output voltage has reached a certain level.

### BACKGROUND

1. Field of the Invention

The present invention is related to non-volatile memory devices (“flash memory devices”), and more particularly, to low voltage booster circuits used in flash memory devices.

2. Background

Semiconductor memory devices have become popular for use in various electronic devices. For example, non-volatile semiconductor memory is used in cellular telephones, digital cameras, personal digital assistants, mobile computing devices, non-mobile computing devices and other electronic devices. Electrical Erasable Programmable Read Only Memory (EEPROM) and flash memory are among the most popular non-volatile semiconductor memories.

Flash memory devices are comprised of an array of memory cells that are selected by word lines extending along rows of the memory cells, and bit lines extending along columns of the memory cells. Low voltage booster circuits are used to generate a voltage level higher than a given input voltage and the generated level can be used to transfer high voltage signals through transfer gates.

A typical low voltage booster circuit requires a clock input which will be amplified with an internal clock doubler circuit to achieve fast ramp up of the output voltage. Although the low voltage booster circuit provides a fast ramp up time, it also has the undesirable side effect of high current consumption which generates more heat and more noise in the chip. The high current consumption is a result of two internal capacitors in the low voltage booster circuit that are used to amplify clock signals. Therefore, what is needed is a low voltage booster circuit that provides a fast ramp up time for the output voltage without consuming a large amount of current.

### SUMMARY OF THE INVENTION

In one aspect of the present invention, a method of reducing current consumption in a low voltage booster circuit is provided. The method includes the steps of (a) enabling an input signal to activate plural out of phase clocks; and (b) disabling the input signal after a pre-determined time and after an output voltage has reached a certain level.

In another aspect of the present invention, a system for reducing current consumption in a low voltage booster circuit is provided. The system includes a clock doubler circuit; a high voltage stage circuit, having an output voltage, connected to the clock doubler circuit, wherein an input signal to the clock doubler circuit activates plural out of phase clocks when the input signal is enabled; and the input signal is disabled after a pre-determined time and after the output voltage has reached a certain level.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. The illustrated embodiment is intended to illustrate, but not to limit the invention. The drawings include the following:

FIG. 1 is a block diagram of a low voltage booster circuit;

FIG. 2 is a block diagram of a clock doubler circuit in the low voltage booster circuit of FIG. 1;

FIG. 3 is a schematic diagram of the clock doubler circuit of FIG. 2;

FIG. 4 illustrates a schematic diagram of a high voltage stage circuit of the low voltage booster circuit of FIG. 1;

FIG. 5 illustrates a conventional clocking diagram of the low voltage booster circuit of FIG. 1;

FIG. 6 is a flow diagram for generating an output voltage signal in the low voltage booster circuit of FIG. 1;

FIG. 7 illustrates a clocking diagram of the low voltage booster circuit of FIG. 1, according to one aspect of the present invention; and

FIG. 8 is a flow diagram for reducing current consumption in a low voltage booster circuit, according to one aspect of the present invention.

### DETAILED DESCRIPTION OF THE PREFERRED EMBODIMENTS

To facilitate an understanding of the preferred embodiment, the general architecture and operation of a low voltage booster circuit will be described. The specific architecture and operation of the preferred embodiment will then be described with reference to the general architecture.

### General Description of a Local Booster Circuit Structure

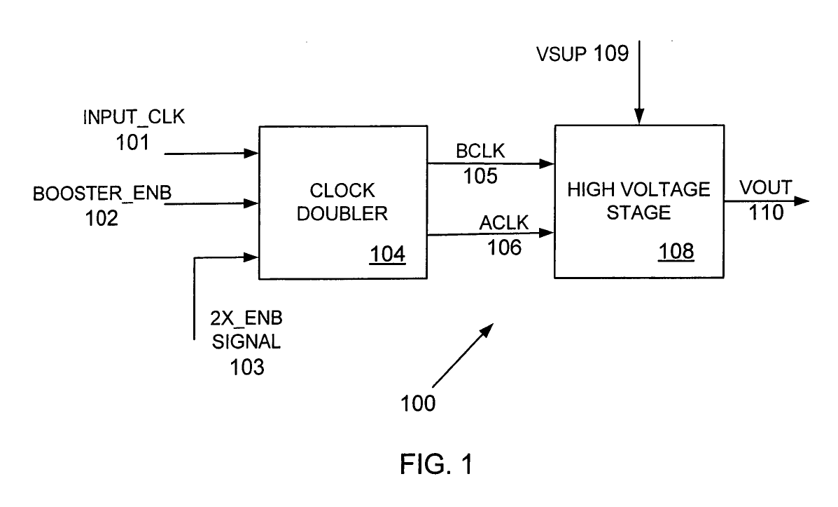

A typical low voltage booster circuit 100 is shown in FIG. 1. Low voltage booster circuit 100 is comprised of a clock doubler circuit 104 connected to a high voltage stage circuit 108. An output voltage VOUT 110 is generated from low voltage booster circuit 100 based on output clock signals, BCLK 105 and ACLK 106, from clock doubler circuit 104 and an input voltage VSUP 109.

Clock doubler circuit 104 receives a clock signal INPUT_CLK 101, an input signal BOOSTER_ENB 102 and an input signal 2X_ENB 103. When BOOSTER_ENB signal 102 and 2X_ENB signal 103 are high, all clock signals within clock doubler circuit 104 are activated and output voltage VOUT 110 of high voltage stage circuit 108 ramps up to a voltage greater than VSUP 109 over a pre-determined time t.

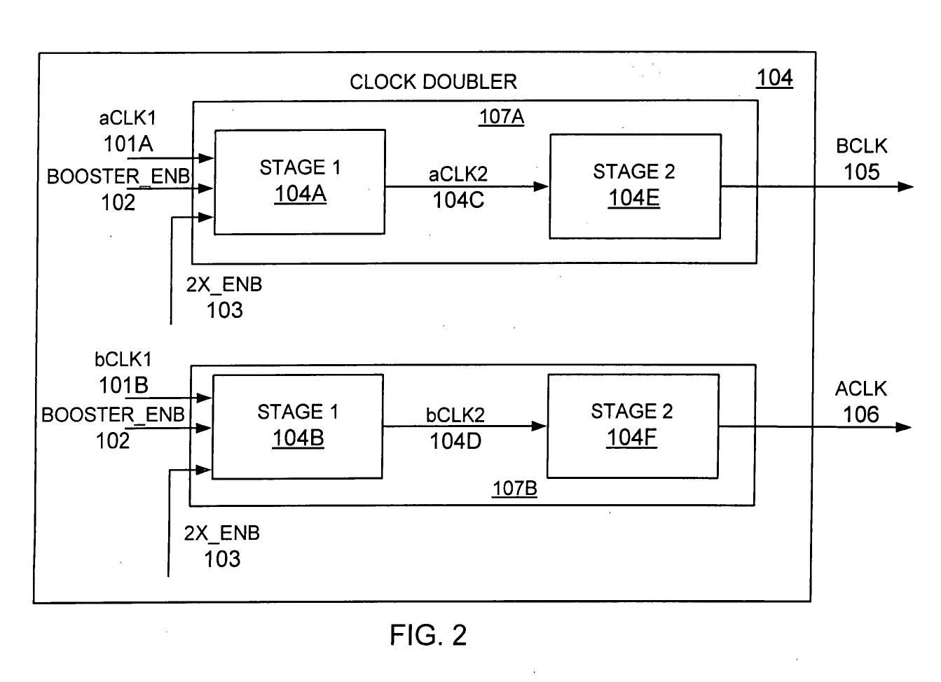

FIG. 2 is a block diagram of clock doubler circuit 104 of FIG. 1. Clock doubler circuit 104 comprises a first process circuit 107A and a second process circuit 107B generating output clock signals BCLK 105 and ACLK 106, respectively. First process circuit 107A is comprised of first stage 1 circuit 104A and first stage 2 circuit 104E, while second process circuit 107B is comprised of second stage 1 circuit 104B and second stage 2 circuit 104F.

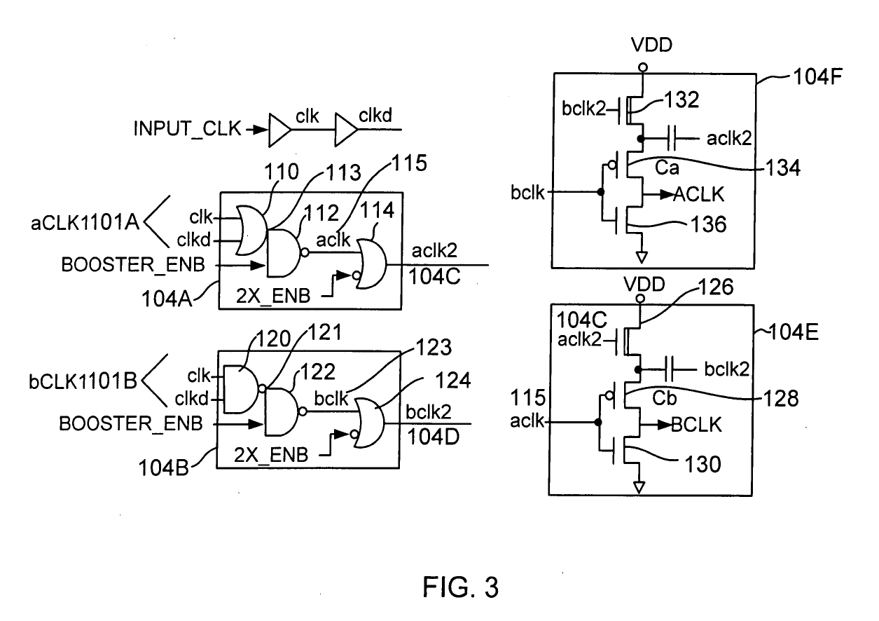

First stage 1 circuit 104A receives clock signal aCLK1 101A, BOOSTER_ENB signal 102 and 2X_ENB signal 103, generating clock signal aCLK2 104C. Clock signal aCLK2 104C is then input into first stage 2 circuit 104E generating output clock signal BCLK 105. Clock signal aCLK1 101A is comprised of a clock signal “clk” and a delayed clock signal “clkd” (see FIG. 3).

Second stage 1 circuit 104B receives clock signal bCLK1 101B, BOOSTER_ENB signal 102 and 2X_ENB signal 103 generating clock signal bCLK2 104D. Clock signal bCLK2 104D is then input into second stage 2 circuit 104F generating output clock signal ACLK 106. Clock signal bCLK1 101B is comprised of clock signal “clk” and delayed clock signal “clkd” (see FIG. 3).

Output clock signals (or “plural out of phase clocks”) BCLK 105 and ACLK 106 are reverse phase and input into high voltage stage 108 allowing output voltage VOUT 110 to ramp up to a certain level, a voltage greater than input voltage VSUP 109 over pre-determined time t. Because the voltage of BCLK 105 and ACLK 106 are amplified by second stages 104E and 104F, their voltage levels are in the same range of a 3V booster circuit where VDD is 3V, therefore the ramp up speed of both boosters will be similar.

FIG. 3 is a schematic diagram of clock doubler circuit 104 of FIG. 2 showing the internal circuitry of first and second stage 1 circuits 104A and 104B and first and second stage 2 circuits 104E and 104F. First stage 1 circuit 104A includes a first OR-gate 110, a first NAND-gate 112, and a second OR-gate 114. First OR-gate 110 receives clock signal “clk” and delayed clock signal “clkd” generating an output signal 113 which is input into first NAND-gate 112 along with BOOSTER_ENB signal 102. The output of first NAND-gate aclk 115 is input into second OR-gate 114 along with inverted 2X_ENB signal 103 generating clock signal aclk2 104C.

Second stage 1 circuit 104B includes a second NAND-gate 120, a third NAND-gate 122 and a third OR-gate 124. Second NAND-gate 120 receives clock signal “clk” and delayed clock signal “clkd” generating an output signal 121 which is input into third NAND-gate 122 along with BOOSTER_ENB signal 102. The output of third NAND-gate bclk 123 is input into third OR-gate 124 along with inverted 2X_ENB signal 103 generating clock signal bclk2 104D.

First stage 2 circuit 104E includes three MOSFET transistors 126, 128, 130 and a first capacitor Cb. The output of first stage 1 circuit aclk 115 and aclk2 104C is input into transistor 126 while clock signal aclk 115 is input into transistor 130 and inverted clock signal aclk 115 is input into transistor 128.

Second stage 2 circuit 104F includes three MOSFET transistors 132, 134, 136 and a second capacitor Ca. The output of second stage 2 circuit bclk 123 and bclk2 104D is input into transistor 132 while clock signal bclk 123 is input into transistor 136 and inverted clock signal bclk 123 and input into transistor 134.

First capacitor Cb in first stage 2 circuit 104E is connected between a corresponding transistor pair 126 and 128 and clock signal aclk2 115 allowing clock signal BCLK 105 to be amplified to nearly twice as high as VDD, where VDD is the amplitude of INPUT_CLK signal 101.

Second capacitor Ca in second stage 2 circuit 104F is connected between a corresponding transistor pair 132 and 134 and clock signal bclk2 123 allowing clock signal ACLK 106 to be amplified to nearly twice as high as VDD. By amplifying output clocks ACLK 106 and BCLK 105, the clock voltage becomes competitive to that of a high voltage booster circuit (3V); therefore ramp up time of low power supply booster is competitive to that of a high voltage booster as well. However, first and second capacitors Cb and Ca also cause the undesired effect of high current consumption in the circuits.

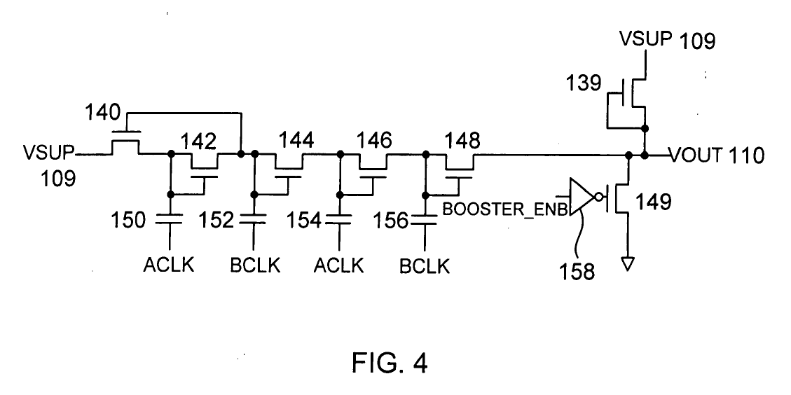

FIG. 4 illustrates a schematic diagram of high voltage stage 108 of low voltage booster circuit 100 of FIG. 1. High voltage stage 108 includes transistors 139, 140, 142, 144, 146, 148, 149 and capacitors 150, 152, 154, 156, each of which has a first terminal connected to the respective gates of transistors 142, 144, 146, 148 and between a corresponding transistor pair 140 and 142, 142 and 144, 144 and 146, 146 and 148, respectively. The second terminal of capacitors 150 and 154 are connected to output clock signal ACLK 106 while the second terminal of capacitors 152 and 156 are connected to output clock signal BCLK 105. Source terminals of transistors 139 and 140 are connected to input voltage VSUP 109. BOOSTER_ENB signal 102 is transmitted through an inverter 158 and input into the gate of transistor 149. ACLK 106 and BCLK 105 are activated while BOOSTER_ENB signal 102 is high and the output voltage VOUT is regulated at VSUP+Vt where Vt is the threshold voltage of transistor 139.

By applying boosted output clock signals ACLK 106 and BCLK 105 to high voltage stage 108, the ramp up time for output voltage VOUT 110 is competitive to a high voltage booster circuit (3V). However, current consumption is larger than the high voltage booster circuit (3V) because of the current consumed in clock doubler 104 by first and second capacitors Cb and Ca.

### Clocking Diagram for a Local Booster Circuit

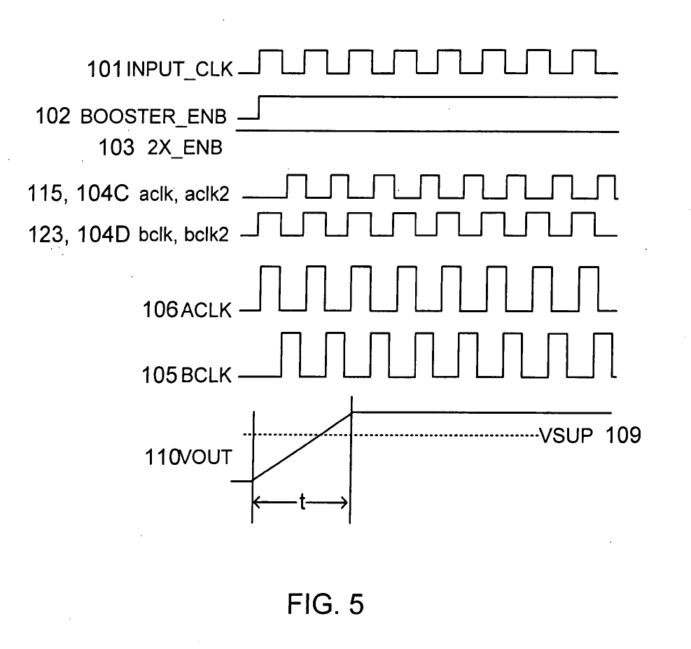

FIG. 5 illustrates a conventional clocking or timing diagram of low voltage booster circuit 100 of FIG. 1. Once input BOOSTER_ENB 102 becomes high, internal clocks aclk 115, aclk2 104C, bclk 123, bclk2 104D, ACLK 106, and BCLK 105 are activated, and an output of local booster VOUT starts to ramp up. 2X_ENB signal 103 is continuously high in order to boost clock signals ACLK 106 and BCLK 105 to amplitude close to twice as high as VDD. Output voltage VOUT 110 ramps up to VSUP+Vt where Vt is the threshold voltage of transistor 139, in pre-determined time t.

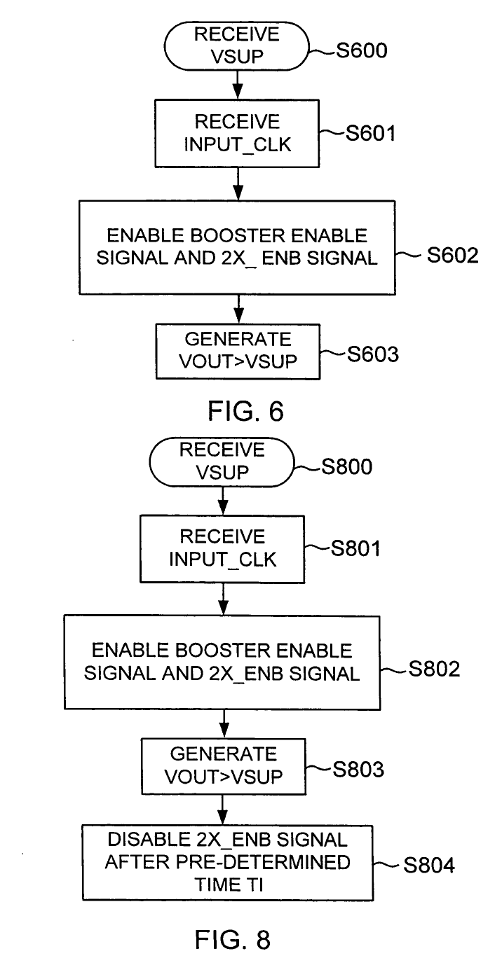

FIG. 6 is a flow diagram showing the steps of generating an output voltage signal in low voltage booster circuit 100 of FIG. 1. In step S600, low voltage booster circuit 108 receives input voltage VSUP 109. In step S601, low voltage booster circuit 100 receives INPUT_CLK 101 and in step S602 BOOSTER_ENB signal 102 and 2X_ENB signal 103 are enabled. In step S603, output voltage VOUT is generated over pre-determined time t and is greater than VSUP 109.

### Clocking Diagram for a Local Booster Circuit to Reduce Current Consumption

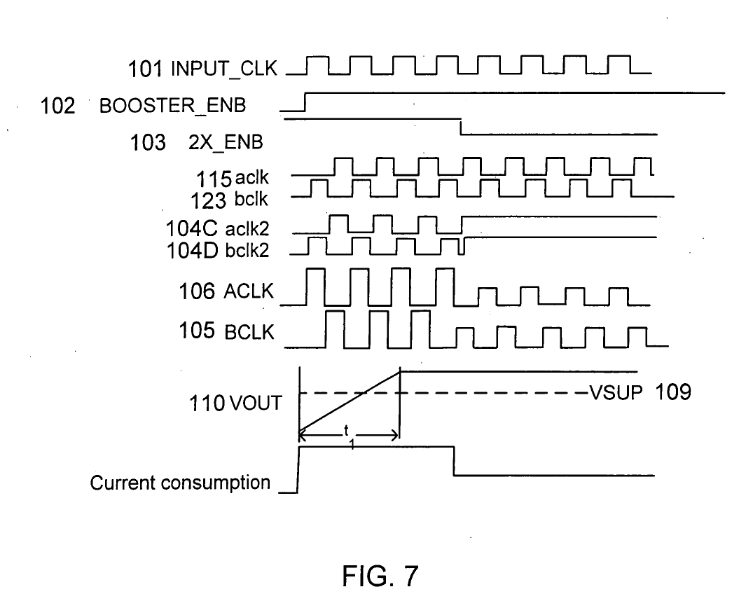

FIG. 7 illustrates a clocking diagram of low voltage booster circuit 100 of FIG. 1, according to one aspect of the present invention. As with the clocking diagram in FIG. 5, once BOOSTER_ENB signal 102 becomes high, internal clocks aclk 115, aclk2 104C, bclk 123, bclk2 104D, ACLK 106, and BCLK 105 are activated, and output of local booster VOUT starts to ramp up. However, unlike the clocking diagram of FIG. 5, 2X_ENB signal 103 is disabled after a pre-determined period t₁, allowing aclk2 104C and bclk2 104D to be disabled. During ramp up, clock signals ACLK 106 and BCLK 105 are boosted from INPUT_CLK signal amplitude VDD to an amplitude close to twice as high as VDD, and then reduced back to INPUT_CLK signal amplitude VDD upon disabling 2X_ENB signal 103 and clock signals aclk2 104C and bclk2 104D. By disabling 2X_ENB signal 103 after pre-determined ramp up time t₁ and reducing the amplitude of output clock signals ACLK 106 to BCLK 105 to INPUT_CLK signal amplitude VDD, current consumption in low voltage booster circuit 100 is reduced, as can be seen in FIG. 7.

Factors such as the output load connected to VOUT, voltage of VSUP, and current drivability of the transistors within local booster circuits will determine ramp up time t₁, which can be estimated by simulation or circuit testing. Pre-determined time t₁ can be pre-programmed based on above mentioned simulation and circuit testing.

FIG. 8 is a flow diagram showing the steps of reducing current consumption in low voltage booster circuit 100. For reducing current consumption, the same steps as in FIG. 6 are followed with the addition of a step of disabling 2X_ENB signal 103. In step S800, high voltage booster circuit 108 receives input voltage Vsup 109. In step S801, low voltage booster circuit 100 receives INPUT_CLK 101 and in step S802 BOOSTER_ENB signal 102 and 2X_ENB signal 103 are enabled. In step S803, output voltage Vout is generated over pre-determined time t and is greater than Vsup 109. Finally, in step S804, 2X_ENB signal 103 is disabled after predetermined time t₁.

Although the present invention has been described with reference to specific embodiments, these embodiments are illustrative only and not limiting. Many other applications and embodiments of the present invention will be apparent in light of this disclosure and the following claims.

What is claimed is:

1. A method of reducing current consumption in a low voltage booster circuit, comprising the steps of:
(a) enabling an input signal to activate plural out of phase clocks; and
(b) disabling the input signal after a pre-determined time and after an output voltage has reached a certain level.

2. The method of claim 1, wherein the low voltage booster circuit is comprised of a clock doubler circuit connected to a high voltage stage circuit.

3. The method of claim 1, wherein the input signal doubles the amplitude of the plural out of phase clocks.

4. The method of claim 2, wherein the pre-determined time is determined by transistors in the low voltage booster circuit and the load connected to the output of the low voltage booster circuit.

5. The method of claim 1, wherein the predetermined time can be pre-programmed based on simulation and circuit testing.

6. The method of claim 3, wherein the amplitudes of the plural out of phase clocks are reduced when the input signal is disabled.

7. A system for reducing current consumption in a low voltage booster circuit, comprising:
a clock doubler circuit;
a high voltage stage circuit, having an output voltage, connected to the clock doubler circuit, wherein an input signal to the clock doubler circuit activates plural out of phase clocks when the input signal is enabled; and
the input signal is disabled after a pre-determined time and after the output voltage has reached a certain level.

8. The system of claim 7, wherein the pre-determined ramp up time is determined by transistors in the low voltage booster circuit and the load connected to the output of the low voltage booster circuit.

9. The system of claim 7, wherein the predetermined time can be pre-programmed based on simulation and circuit testing.

10. The system of claim 7, wherein the plural out of phase clocks are input into the high voltage stage circuit.

11. The system of claim 7, wherein the input signal doubles the amplitude of the plural out of phase clocks.

12. The method of claim 11, wherein the amplitudes of the plural out of phase clocks are reduced when the input signal is disabled.
